(19) United States
(12) Patent Application Publication
(10) Pub. No.: US 2015/0207286 A1
(43) Pub. Date: Jul. 23, 2015

(54) PHONE MOUNT

(71) Applicants: Liang Chen, San Jose, CA (US); Yongchang Wang, San Jose, CA (US)

(72) Inventors: Liang Chen, San Jose, CA (US); Yongchang Wang, San Jose, CA (US)

(21) Appl. No.: 14/161,536

(22) Filed: Jan. 22, 2014

(51) Int. Cl. H01R 33/90

(52) U.S. Cl. CPC H01R 33/90

(57) ABSTRACT

A phone mount system includes a slot installer that installs into a slot of a CD player or cassette player. A controller and circuitry assembly includes a plurality of connector plugs. Each connector plug in the plurality of connector plugs has a different charger interface than other connector plugs in the plurality of connector plugs.

### BACKGROUND

Smart phones provide a versatile wealth of functionality including the functionality of a personal digital assistant, a portable media player, a digital camera, a web browser, a global positioning system (GPS) and so on.

There are restrictions, however, on smart phone usage while driving. For example, in California it is unlawful to drive a motor vehicle while using a wireless telephone unless the telephone is specifically designed and configured to allow hands free listening and talking, and is used in that manner while driving. Even handheld use of a smart phone for GPS navigation has been found to violate the California Vehicle Code.

### BRIEF DESCRIPTION OF DRAWINGS

FIG. 1 shows a phone mount system in place on a car dashboard in accordance with an embodiment.

FIG. 2 is an exploded view of the phone mount system shown in FIG. 1 in accordance with an embodiment.

FIG. 3 is an exploded view of a portion of the phone mount system shown in FIG. 1 in accordance with an embodiment.

FIG. 4 and FIG. 5 show implementation detail of a portion of the phone mount system shown in FIG. 1 in accordance with an embodiment.

FIG. 6 is a simplified block diagram illustrating functionality of the phone mount system shown in FIG. 1 in accordance with an embodiment.

### DETAILED DESCRIPTION

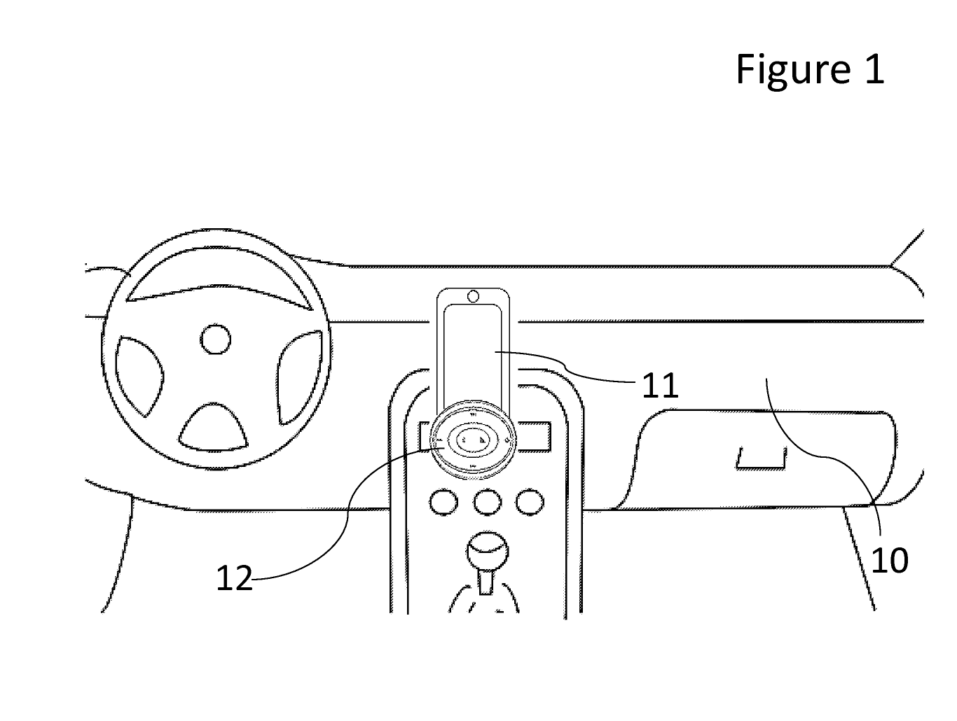

FIG. 1 shows a phone mount system 12 mounted on a vehicle dashboard 12. Phone mount system 12 is securely holding a smart phone 11. For example, smart phone 11 is in communication with phone mount system 12 through the Bluetooth wireless technology standard. Alternatively, smart phone 11 may be in communication with phone mount system 12 through another wireless or wired communication protocol. Phone mount system 12 is connected to the vehicle speakers and has an integrated microphone. This connection allows users of smart phone 11 to utilize the speakers of the vehicle and the internal microphone of phone mount system 12 to make phone calls, play music and other content, give verbal instructions and receive GPS navigation directions and so on. Phone mount system 12 has a selection of smart phone interfaces allowing a mounted smart phone to be charged via power phone mount system 12 obtains from plugging into a standard 12 volt DC receptacle of the vehicle.

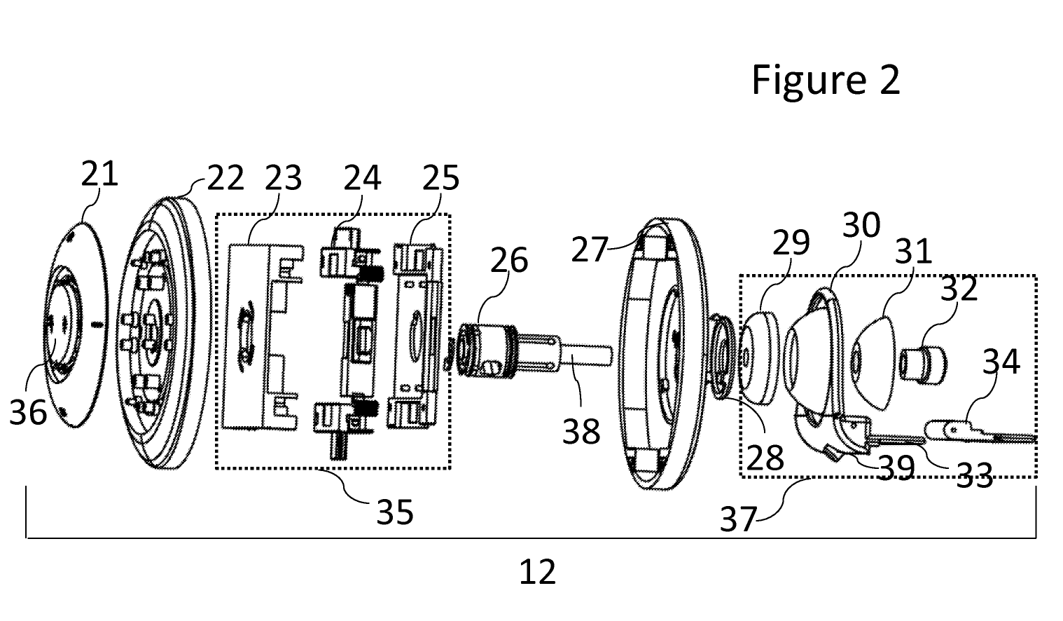

FIG. 2 is an exploded view of phone mount system 12. A button housing 21 provides housing for a control button 36. A clip portion 22 and a clip portion 27 are used to hold smart phone 11 firmly in position. Clip portion 27 can be pushed backward and left un-rebounded. The design of clip portion 22 and clip portion 27 allow a user to mount a phone with a single hand and rotate a charging interface into position with a single hand.

A controller and charger 35 includes charging and control circuit 24 contained within a housing portion 23 and a housing portion 25. Controller and charger 35, clip portion 22 and clip portion 27 are all connected to axel 26. As explained more fully below, controller and charger 35 rotates around an axel 26 to allow a connector that matches smart phone 11 to be placed in a vertical orientation. This allows phone 11 to be mounted in an upright position for charging and ease of use by a driver or passenger of the vehicle.

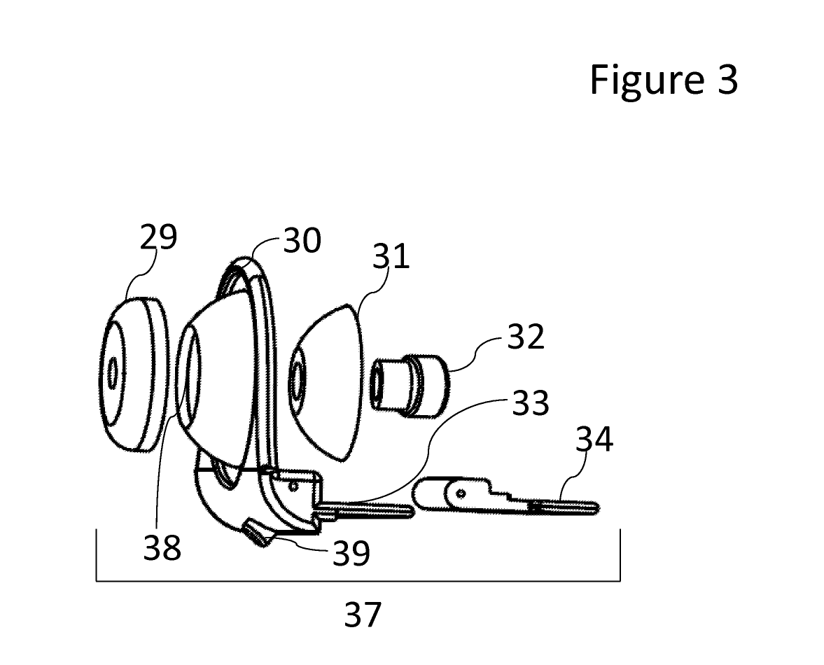

As shown in both FIG. 2 and FIG. 3, a slot installer 37 includes an insert section 33 connected to a connection structure 30. A washer 29 is used to hold connection structure 30 against a cap 28 adjacent to clip portion 27. Cap 32 attaches to an end 38 of axel 26 so there is tension between connection structure 30, washer 29 and a washer 31 and the tightness of viewer angle adjustment is tunable. An insert section 33 and an insert section 34 are inserted into a CD slot or a cassette slot of vehicle dashboard 10, shown in FIG. 1. By changing an opening angle between insert section 33 and insert section 34, slot installer 37 is wedged tightly in the CD slot or the cassette slot of vehicle dashboard 10. For example, a knob 39 is used to adjust an opening angle between insert section 33 and insert section 34. Turning knob 39 in a first direction (e.g., clockwise) increases the opening angle and turning knob 39 in an opposite direction (e.g., counter-clockwise) decreases the opening angle. The larger the opening angle between insert section 33 and insert section 34, the stronger the force holding slot installer 37 in the CD slot or the cassette slot.

A large opening 38 within connection structure 30 allows adjustment of position of washer 29 and a washer 31 with respect to connection structure 30. This allows adjustment of a viewing angle of smart phone 11 when mounted on phone mount system 12.

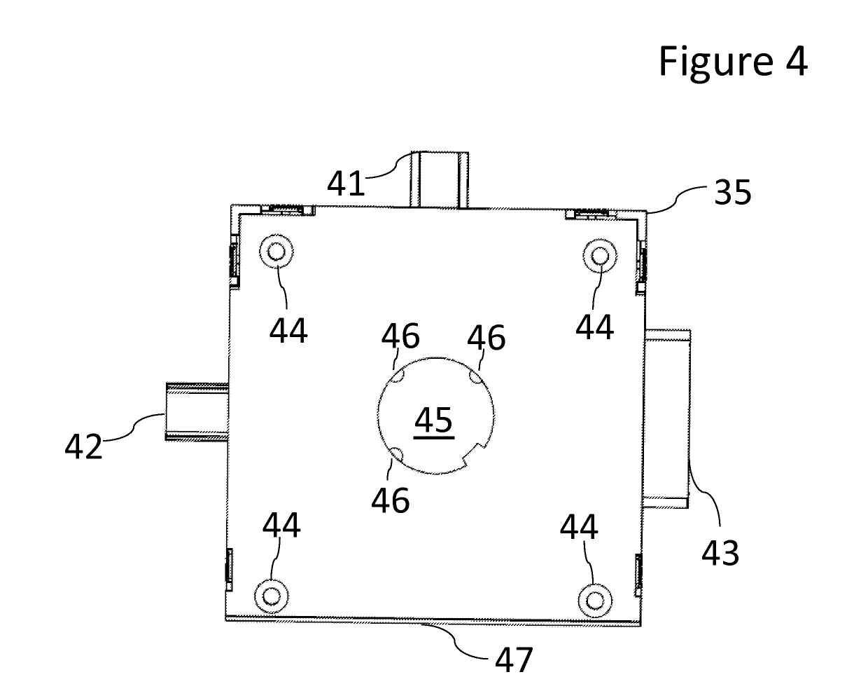

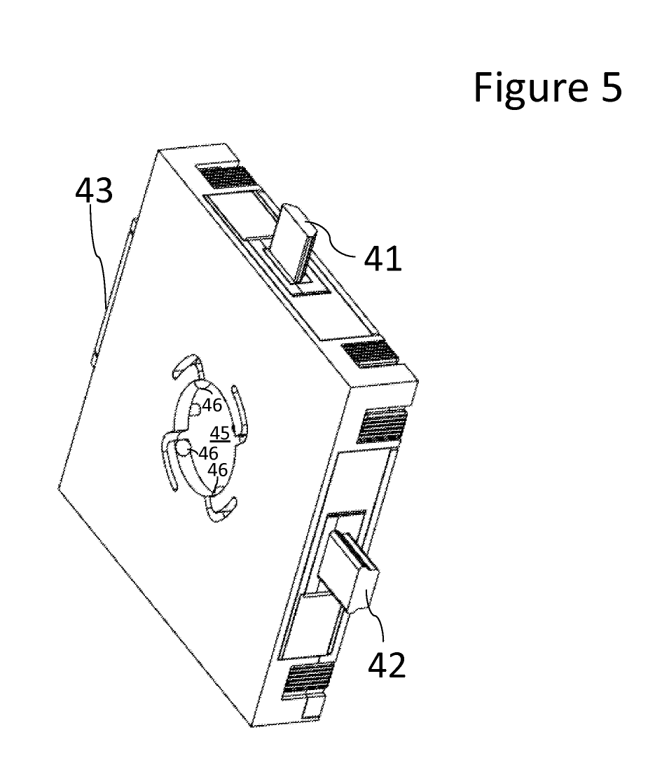

A top view of controller and charger 35, as assembled, is shown in FIG. 4. A top front side perspective view of controller and charger 35, as assembled is shown in FIG. 5. Screws 44 or other attachment mechanisms hold together housing portion 23 and housing portion 25, encasing charging and control circuit 24. Charging and control circuit 24 includes three different types of connector plugs allowing controller and charger 35 to plug into and charge smart phones with different charger interfaces. For example, in FIG. 4 are shown a connector plug 41, a connector plug 42 and a connector plug 43. For example connector plug 41 is a micro universal serial bus (USB) plug, connector plug 42 fits a lightning eight-pin connector interface of an Apple iPhone 5 smart phone and connector plug 43 fits a 30 pin connector interface of an Apple iPhone 4 smart phone. While FIG. 4 shows controller and charger 35 having four sides and three connector plugs, controller and charger 35 can have other shapes and/or other numbers of connector plug. For example, controller and charger 35 can have three sides and two connector plugs or five sides and four connector plugs. Additionally, controller and charger 35 could have connector plugs on every side (not just three out of four sides) or could have connector plugs on only two out of four sides. Alternatively, controller and charger 35 could have more than one connector plug per side.

Axel 26 fits through hole 45. Bearings 46 allow rotation of controller and charger 35 around and locks controller and charger into four positions. In a first position, connector plug 42 faces upward allowing a smart phone with a matching connector to be mounted onto connector plug 42 for charging. The smart phone is well position to be used, for example, for GPS navigation and other applications. In a second position, connector plug 41 faces upward allowing a smart phone with a matching connector to be mounted onto connector plug 41 for charging. The smart phone with a plug matching connector plug 41 will be in good position to be used, for example, for GPS navigation and other applications.

In a third position, connector plug 43 faces upward allowing a smart phone with a matching connector to be mounted onto connector plug 43 for charging. The smart phone with a plug matching connector plug 41 will be in good position to be used, for example, for GPS navigation and other applications.

In a fourth position, a flat end 47 of controller and charger 35 faces upward. A smart phone will be held firmly in place by clip portion 22 and clip portion 27, shown in FIG. 2. While the smart phone in this position will not be charged by controller and charger 35, the smart phone will be in good position to be used, for example, for GPS navigation and other applications.

Once smart phone 11 is in contact with smart phone 12 through the Bluetooth wireless technology standard, or some other connection protocol, a user can receive calls by pressing control button 36. Likewise, when playing music or other stored content, a user first start a content player in phone 11 and then make additional control selections using control button 36 or by using recognized voice commands.

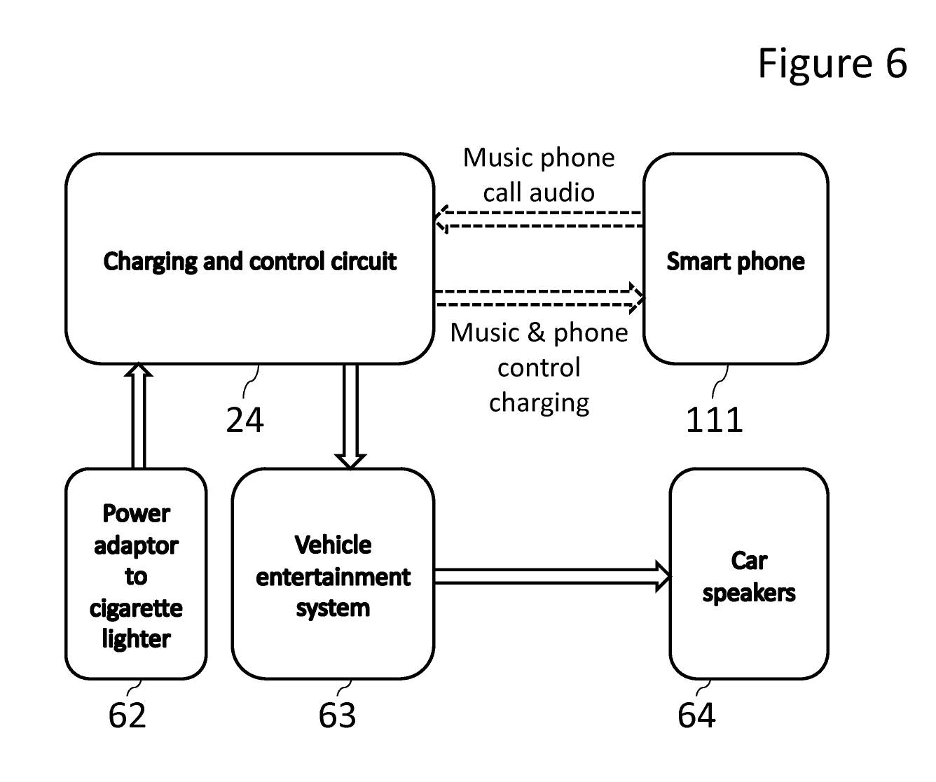

FIG. 6 is a simplified block diagram illustrating connectivity of charging and control circuit 24. Charging and control circuit 24 includes a Bluetooth module for Bluetooth wireless communication with smart phone 11 or some other Bluetooth enabled device such as an MP3 player, voice command device, etc. A Bluetooth connection enables phone calls, music plays, voice commands and so on. Charging and control circuit 24 provides power to connector plug 41, connector plug 42 and connector plug 43. Charging and control circuit 24 also receives user selection through control button 36. Through a plug adapter and cable, charging and control circuit 24 is connected to a standard 12 volt DC receptacle 62 of vehicle 10. Charging and control circuit 24 includes a receptacle for an audio cable that allows connection of charging and control circuit 24 to a cable from a vehicle entertainment system 63. Charging and control circuit 24 also includes a radio signal transmitter for transmittal of radio signals that allows charging and control circuit 24 to transmit radio signals, for example FM radio signals, to the vehicle entertainment system when the vehicle entertainment system does not have audio cable that allows a direct wired connection. Vehicle entertainment system 63 is hardwired to speakers 64 allowing charging and control circuit 24 to utilize speakers 64 via transmissions from charging and control circuit 24 to vehicle entertainment system 63.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A phone mount system comprising:
a slot installer that installs into a slot of a CD player or cassette player; and,
a controller and circuitry assembly that includes a plurality of connector plugs, each connector plug in the plurality of connector plugs having a different charger interface than other connector plugs in the plurality of connector plugs;
wherein the controller and circuitry assembly rotates with respect to the slot installer so that when a phone charger interface of a phone is connected to a connector plug in the plurality of connector plugs the interfaces with the phone charger interface, the controller and circuitry assembly can be rotated so that the phone is held in an upright position with respect to a user.

2. A phone mount system as in claim 1 additionally comprising:
a first clip portion and a second clip portion;
wherein a side of the controller and circuitry assembly does not have a connector plug, the first clip portion and the second clip portion arranged to hold the phone firmly in an upright position when the controller and circuitry assembly is rotated so that the side of the controller is facing up and the phone is placed on the side of the controller and circuitry assembly; and,
wherein the second clip portion can be pushed backward and left un-rebounded to allow a user to mount a phone with a single hand.

3. A phone mount system as in claim 1 wherein the controller and circuitry assembly comprises:
a Bluetooth module for Bluetooth wireless communication with the phone.

4. A phone mount system as in claim 1 wherein the controller and circuitry assembly comprises:
a module that provides wireless communication with the phone.

5. A phone mount system as in claim 1 wherein the slot installer is arranged to allow viewer angle adjustment of the phone and wherein tightness of viewer angle adjustment is tunable.

6. A phone mount system as in claim 1 wherein the controller and circuitry assembly includes four sides with a connector plug from the plurality of connector plugs being mounted on three of the four sides.

7. A phone mount system as in claim 1 wherein a first connector plug is a micro universal serial bus (USB) plug, a second connector pin is a 30-pin connector and a third pin is a lightening eight-pin connector.

8. A phone mount system as in claim 1 additionally comprising a controller button on a front of the phone mount system.

9. A phone mount system as in claim 1 additionally comprising a power adapter for a 12 volt DC receptacle of a vehicle.

10. A phone mount system as in claim 1 wherein the controller and circuit assembly includes a receptacle for an audio cable.

12. A phone mount system as in claim 1 wherein the controller and circuit assembly includes a radio signal transmitter for transmittal of radio signals to a vehicle radio.

13. A phone mount system comprising:
a slot installer that installs into a slot of a CD player or cassette player;
a controller and circuitry assembly that includes a plurality of connector plugs, each connector plug in the plurality of connector plugs having a different charger interface than other connector plugs in the plurality of connector plugs; and,
a Bluetooth module for Bluetooth wireless communication with a Bluetooth enabled device.

14. A phone mount system as in claim 13 additionally comprising
a first clip portion and a second clip portion;
wherein the controller and circuitry assembly rotates with respect to the slot installer so that when a charger interface of the Bluetooth enabled device phone is connected to a connector plug in the plurality of connector plugs the interfaces with the charger interface, the controller and circuitry assembly can be rotated so that the phone is held in an upright position with respect to a user; and
wherein a side of the controller and circuitry assembly does not have a connector plug, the first clip portion and the second clip portion arranged to hold the phone firmly in an upright position when the controller and circuitry assembly is rotated so that the side of the controller is facing up and the phone is placed on the side of the controller and circuitry assembly.

15. A phone mount system as in claim 13 wherein the slot installer is arranged to allow viewer angle adjustment of the phone and wherein tightness of viewer angle adjustment is tunable.

16. A phone mount system as in claim 13 wherein a first connector plug is a micro universal serial bus (USB) plug, a second connector pin is a 30-pin connector and a third pin is a lightening eight-pin connector.

17. A phone mount system as in claim 13 additionally comprising a controller button on a front of the phone mount system.

18. A phone mount system as in claim 13 additionally comprising a power adapter for a 12 volt DC receptacle of a vehicle.

19. A phone mount system as in claim 13 wherein the controller and circuit assembly includes a receptacle for an audio cable.

20. A phone mount system as in claim 13 wherein the controller and circuit assembly includes a radio signal transmitter for transmittal of radio signals to a vehicle radio.
